(19) United States
(12) Patent Application Publication
(10) Pub. No.: US 2026/0356139 A1
(43) Pub. Date: Nov. 12, 2026

(54) METHOD FOR OPERATING A TIRE SENSOR AND TIRE SENSOR

(71) Applicant: Robert Bosch GmbH, Stuttgart (DE)

(72) Inventor: Roman Foell, Grossbettlingen (DE)

(21) Appl. No.: 19/657,161

(22) Filed: Apr. 24, 2026

(30) Foreign Application Priority Data
May 8, 2025 (DE) 10 2025 117 639.6

(51) Int. Cl. B60C 23/04

(52) U.S. Cl. CPC B60C 23/0488

(57) ABSTRACT

A method for operating a tire sensor attachable to a vehicle tire. The method includes: detecting at least one acceleration signal from an acceleration sensor of the tire sensor; calculating a centrifugal acceleration value according to the acceleration signal; calculating a rotation period value of a rotation period of a tire revolution of the vehicle tire at least according to the centrifugal acceleration value; calculating a sampling frequency according to the rotation period value; detecting at least one further acceleration signal from the acceleration sensor by measurement at the sampling frequency and calculating at least one rotation direction of the vehicle tire at least according to the further acceleration signal. A tire sensor is also described.

### CROSS REFERENCE

The present application claims the benefit under 35 U.S.C. § 119 of Germany Patent Application No. DE 10 2025 117 639.6 filed on May 8, 2025, which is expressly incorporated herein by reference in its entirety.

### FIELD

The present disclosure relates to a method for operating a tire sensor. The present disclosure further relates to a tire sensor.

### BACKGROUND INFORMATION

Germany Patent Application No. DE 10 2021 209 055 A1 describes a method for ascertaining wheel positions of vehicle wheels on a vehicle. In each case, acceleration sensors are arranged on at least two vehicle wheels. The measured radial acceleration is used to ascertain a period length, and for the measured tangential acceleration, temporal positions of a first and a second acceleration extremum are compared with ABS speed data, and from this the wheel positions of the acceleration sensors (front-left, rear-left, front-right, rear-right) on the vehicle are calculated.

### SUMMARY

According to the present disclosure, a method for operating a tire sensor attachable to a vehicle tire is provided. The method includes: detecting at least one acceleration signal from an acceleration sensor of the tire sensor; calculating a centrifugal acceleration value according to the acceleration signal; calculating a rotation period value of a rotation period of a tire revolution of the vehicle tire at least according to the centrifugal acceleration value; calculating a sampling frequency according to the rotation period value; detecting at least one further acceleration signal from the acceleration sensor by measurement at the sampling frequency; and calculating at least one rotation direction of the vehicle tire at least according to the further acceleration signal.

This reduces the number of processing steps and makes the operation of the tire sensor more energy-saving and more computationally efficient. The tire sensor can more accurately and more quickly ascertain the parameters to be measured.

The following features, inserted in parentheses, possibly separated by commas and therefore to be taken separately from one another or in combination with one another, are to be understood as alternative, optional, supplementary, restrictive, clarifying, exemplary, expansive and/or explanatory information relating to the feature preceding the parentheses.

The vehicle can be a motor vehicle or a utility vehicle. The vehicle can have at least one vehicle axle with at least two vehicle tires. The vehicle can be a motorized and mobile device.

The vehicle tire can be arranged on the left-hand or right-hand side in the direction of travel in relation to the vehicle.

The tire sensor can be a tire pressure sensor (TPMS). The tire sensor can have the at least one acceleration sensor. The tire sensor can be arranged on the vehicle tire, in particular on a vehicle rim of the vehicle tire.

The acceleration signal can be a measurement signal from the acceleration sensor. The acceleration signal can be output by a communication interface (wirelessly, via a radio signal, via Bluetooth). The tire sensor can have the communication interface.

The acceleration signal can comprise a first and a second acceleration signal. The first acceleration signal can be a measured tangential acceleration of the acceleration sensor. The second acceleration signal can be a measured radial acceleration of the acceleration sensor. The first and the second acceleration signal can measure mutually orthogonal accelerations. The first and the second acceleration signal can refer to mutually perpendicular measurement axes (acceleration axes).

The centrifugal acceleration value a_{c} can be calculated according to the first acceleration signal aₓ (the tangential acceleration value, the amplitude of the first acceleration signal) and the second acceleration signal a_{z} (the radial acceleration value, the amplitude of the second acceleration signal) as follows

$${a}_{c} = \sqrt{{a}_{x}^{2} + {a}_{z}^{2}}$$

The acceleration sensor can measure the acceleration in at least (at most, exactly) two measurement axes. The measurement axes can be mutually perpendicular. One of the measurement axes can specify the first acceleration signal (the tangential acceleration) and the other measurement axis the second acceleration signal (the radial acceleration).

The further acceleration signal can be ascertained by the same components of the acceleration sensor as the acceleration signal. The further acceleration signal can differ from the acceleration signal in that the boundary conditions (such as the sampling frequency, the measurement time) deviate relative to the measurement of the acceleration signal. The further acceleration signal can be detected in another time segment or at a newly set sampling frequency relative to the acceleration signal.

The rotation period can correspond to the duration of one full revolution of the vehicle tire.

The rotation period value p₁ can initially be calculated using the centrifugal acceleration value a_{c} and an assumed initial (estimated) tire radius Rᵢₙᵢₜᵢₐₗ. The tire radius can be the distance between the wheel center of the vehicle tire and the radial position of the acceleration sensor (on the vehicle tire). The direction of travel (forward or backward) of the vehicle can be known when calculating the rotation period value. The rotation period value can be calculated as follows

$${p}_{1} = 2 π \sqrt{\frac{{R}_{initial}}{{a}_{c}}}$$

The sampling frequency can specify the number of acceleration measurement values of the acceleration signal per rotation period (rotation period value, full revolution of the vehicle tire). The sampling frequency f can be calculated according to the rotation period (the rotation period value p₁) by dividing a predefined number S of acceleration measurement values of the acceleration signal by the rotation period (the rotation period value), in particular

$$f = \frac{S}{{p}_{1}}$$

In a preferred embodiment of the present disclosure, it is advantageous if a further rotation period value is calculated by sinusoidal curve fitting of the further acceleration signal. The further rotation period value p₂ can be output. The further rotation period value can be output at the same time as the rotation direction D. Sinusoidal curve fitting (sinusoidal fitting) can be understood as curve fitting using a least-squares method (RMS method), in particular with application of

aₓ(t)=A sin (ωt+φ)

or analogously the cosine form. The frequency ω can be calculated by reducing the RMS error as much as possible according to the further rotation period value p₂, specifically

$$ω = \frac{2 π}{{p}_{2}}$$

The further rotation period value can be calculated by sinusoidal curve fitting over at least one rotation period. The further rotation period value can be calculated independently of knowledge of the tire radius value (the rim radius value, the tire radius, the rim radius).

The rotation period value can be calculated by sinusoidal curve fitting (analogous to the described step of calculating the further rotation period value) of the first acceleration signal.

A preferred configuration of the present disclosure is advantageous in which a tire radius value is calculated according to the further rotation period value. The tire radius value can be output. The tire radius value can be the distance between the wheel center of the vehicle tire and the radial position of the acceleration sensor (on the vehicle tire).

The tire radius value can be stored for accessing with a subsequent processing step. The tire radius value can be further calculated according to the centrifugal acceleration value or a further centrifugal acceleration value calculated according to the further acceleration signal. The tire radius value R can be calculated according to the further rotation period value p₂ and the centrifugal acceleration value a_{c,1} or the further centrifugal acceleration value a_{c,2} as follows

$$R = \frac{{p}_{2}^{2} {a}_{c , 1 / 2}}{{( 2 π )}^{2}}$$

In an advantageous embodiment of the present disclosure, the rotation period value is further calculated according to a previously calculated tire radius value. The rotation period value can alternatively be calculated using an assumed initial tire radius value. The initial tire radius value can be estimated. The previously calculated tire radius value may have been calculated by a previously performed processing step of the method for operating.

Due to this iterative approach, the tire radius value can be calculated as closely as possible to the actual tire radius. In the iterative calculation, a moving average formation can be applied.

The rotation period value p₁ can be calculated according to the (initial, previously calculated) tire radius value R and the centrifugal acceleration value a_{c} as follows

$${p}_{1} = 2 π \sqrt{\frac{R}{{a}_{c}}}$$

The rotation period value can be calculated with increasing accuracy by iterative adaptation of the tire radius value. As a result, the sampling frequency can be adapted more specifically and more accurately.

Optionally switching between the rotation period value and the further rotation period value is possible for continuous refinement of the rotation period value and/or the tire radius value.

A preferred configuration of the present disclosure is advantageous in which the further acceleration signal comprises a first further acceleration signal and a second further acceleration signal. The first further acceleration signal can be a measured tangential acceleration of the acceleration sensor. The second further acceleration signal can be a measured radial acceleration of the acceleration sensor.

The acceleration sensor can have axes offset by 90°, for detecting the first further acceleration signal (the tangential acceleration) and the second further acceleration signal (the radial acceleration). Due to the first further acceleration signal and the second further acceleration signal, an unambiguous ascertaining of the rotation direction can be made possible.

The further centrifugal acceleration value a_{c,2} can be calculated according to the first further acceleration signal a_{x,2} and the second further acceleration signal a_{z,2} as follows

$${a}_{c , 2} = \sqrt{{a}_{x , 2}^{2} + {a}_{z , 2}^{2}}$$

A preferred configuration of the present disclosure is advantageous in which at least one absolute first extreme value is identified in the first further acceleration signal and one absolute second extreme value is identified in the second further acceleration signal in each case by polynomial curve fitting of the first and the second further acceleration signal. The polynomial curve fitting (polynomial fitting) can be performed with a second-order or higher polynomial.

The first and/or the second extreme value can be a maximum or a minimum. The first and the second extreme value can in each case be a maximum. If a minimum exists for the first and/or the second extreme value, this can be extrapolated to a maximum by shifting it by half a period of the rotation period value.

If the curve fitting cannot ascertain an extreme value (a maximum), the extreme value ascertaining can be performed in a time-shifted time range of the first further acceleration signal and correspondingly of the second further acceleration signal.

If no extreme value (no maximum) can be ascertained overall, for example if there is excessive noise, the extreme value ascertaining can be aborted (and an error output).

In a preferred embodiment of the present disclosure, it is advantageous if the polynomial curve fitting is limited to a signal component, spanned by a time range, of the further acceleration signal and the time range is smaller than one rotation period. The time range can be limited to half a rotation period. The time range can correspond to half a rotation period, since in particular at least one maximum or minimum occurs therein.

If the curve fitting cannot ascertain an extreme value (a maximum), the extreme value ascertaining can be performed in a time range of the first further acceleration signal and correspondingly of the second further acceleration signal that is time-shifted by half a period length of the rotation period. Due to the smaller time range, faster and more energy-efficient calculation can be made possible.

In a specific configuration of the present disclosure, it is advantageous if the rotation direction is calculated according to a relative time position of the first and the second extreme value relative to one another. The rotation direction can be output. For example, if the first and the second extreme value (the maxima) are shifted in a defined sequence (a 90° phase shift), it can be concluded whether the vehicle tire is rotating clockwise or counterclockwise.

The rotation direction (clockwise or counterclockwise) can be calculated from the temporal sequence of the first and the second extreme value (from the sequence of the time positions of the first and the second extreme value, from the sequence of the time positions of the first and the second maximum).

From the rotation direction, a side assignment of the tire sensor (left, right) on the vehicle can be carried out, in particular when the axis orientation (of the measuring axes) of the acceleration sensor is known.

When calculating the rotation direction, a limited time range of the rotation period can be taken into account, in particular a time range of 120°, preferably in order to distinguish the phase position of the extreme values.

The rotation direction can be established as rotating clockwise if the time position of the first extreme value as a maximum is located before the time position of the second extreme value as a maximum by

$$Δ t = \frac{{p}_{1 , 2}}{4} .$$

The rotation direction of can be established as rotating counterclockwise if the time position of the first extreme value as a maximum is located after the time position of the second extreme value as a maximum by

$$Δ t = \frac{{p}_{1 , 2}}{4} .$$

In a preferred embodiment of the present disclosure, the time position of at least the first extreme value is output. The time position of the second extreme value can also be output. The time position can refer to the start of the recording and/or a transmission time at which the information is sent. The time position can be corrected by a time correction value and output as a corrected time position.

The time position of the first extreme value, the rotation direction, the tire radius value, the rotation period and/or the further rotation period can be output simultaneously (at the same time, with a processing step of the method), in particular via the (one, wireless) communication interface.

The time correction value t_{c} can be calculated according to the rotation direction D, the rotation period value p₁ or the further rotation period value p₂, the first acceleration signal aₓ and the second acceleration signal a_{z} (or, analogously, the first further acceleration signal a_{x,2} and the second further acceleration signal a_{z,2}) as follows:

$${t}_{c} = D \cdot \frac{{p}_{1 , 2}}{2 π} {tan}^{- 1} ( - \frac{{a}_{x}}{{a}_{z}} )$$

The corrected time position t_{1,c} can be calculated according to the time position t₁ of the first extreme value as follows

t_{1,c}=t₁+t_{c}

The corrected time position t_{1,c} can be output (via the communication interface).

Using the corrected time position, a loopback time T can be calculated as a time span between the corrected time position and a transmission time tₛ as follows

T=|t_{1,c}−tₛ|

The transmission time can be the time at which at least the information about the time position is transmitted, in particular via a communication interface.

The loopback time can be output via the communication interface (wirelessly, via a radio signal, via Bluetooth).

According to the present disclosure, a tire sensor having the is also provided. The tire sensor can be arranged on the vehicle tire (the vehicle rim) with a predefined orientation (an axis angle, tangentially, radially/orthogonally). As a result, the acceleration signal can be reliably detected and resolved in relation to the acceleration directions (using the measurement axes).

The acceleration sensor can measure the acceleration in at least (at most, exactly) two measurement axes. The measurement axes can be mutually perpendicular.

The tire sensor can comprise a computing unit (a microcontroller) and/or a communication interface (a Bluetooth Low Energy unit). The method for operating the tire sensor can be performed by the tire sensor itself. The calculations can be performed by the computing unit.

Further advantages and advantageous configurations of the present disclosure can be found in the description of the figures and in the figures.

### BRIEF DESCRIPTION OF THE DRAWINGS

The present disclosure is described in detail below with reference to the figures.

FIG. 1 shows a method for operating a tire sensor in a specific example embodiment of the present disclosure.

FIG. 2 shows a tire sensor in a specific embodiment of the present disclosure.

### DETAILED DESCRIPTION OF EXAMPLE EMBODIMENTS

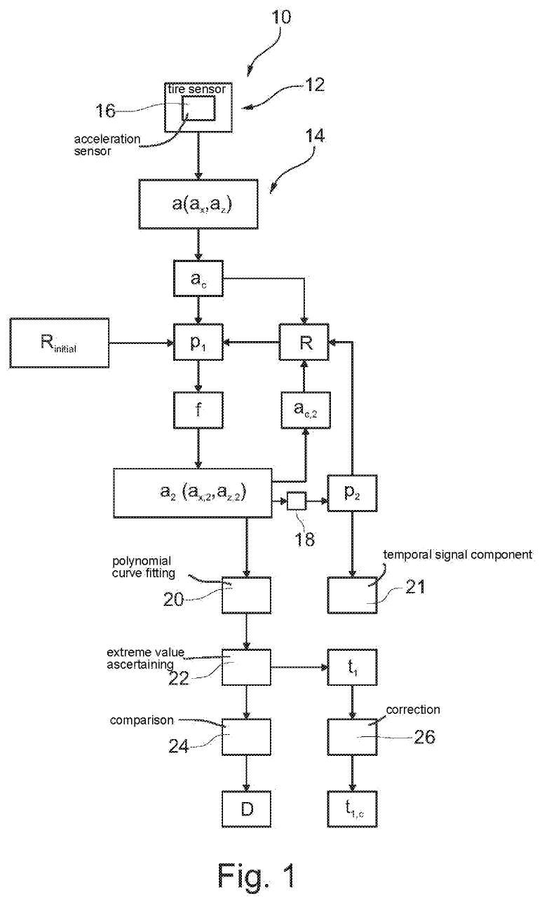

FIG. 1 shows a method for operating a tire sensor in a specific embodiment of the present disclosure. The method for operating 10 a tire sensor 12 comprises initially detecting 14 an acceleration signal a from an acceleration sensor 16 of the tire sensor 12, wherein this acceleration signal a can comprise a first acceleration signal aₓ, for example a tangential acceleration, and a second acceleration signal a_{z}, for example a radial acceleration. The first and the second acceleration signal aₓ, a_{z} can specify the measured accelerations along mutually orthogonal measurement axes of the acceleration sensor 16.

In a next step, a centrifugal acceleration value a_{c} is calculated from the detected acceleration signal a in particular as follows

$${a}_{c} = \sqrt{{a}_{x}^{2} + {a}_{z}^{2}}$$

Following this, a rotation period value p₁ is calculated. Different approaches can be used for this purpose. If a reliable tire radius value R is not yet known, the rotation period value p₁ can be calculated using an assumed initial tire radius value Rᵢₙᵢₜᵢₐₗ and the centrifugal acceleration value a_{c} as follows

$${p}_{1} = 2 π \sqrt{\frac{{R}_{initial}}{{a}_{c}}}$$

If, on the other hand, a previously calculated tire radius value R is already available, it can be used to calculate the rotation period value p₁ more accurately as follows

$${p}_{1} = 2 π \sqrt{\frac{R}{{a}_{c}}}$$

In this way, the rotation period value p₁ can be continuously iteratively refined by incorporating a newly (previously) calculated tire radius value R (calculated with a previous processing step) back into the calculation of the rotation period value p₁.

A sampling frequency f is subsequently derived from this rotation period value p₁, specifically

$$f = \frac{S}{{p}_{1}}$$

with the number S of measurement points within one full rotation period.

This process establishes how many measurement points are to be detected within a single revolution (a rotation period), and from this it is calculated how quickly the acceleration signal a must be sampled in order to obtain sufficient temporal resolution. With the aid of this sampling frequency f, a further acceleration signal a₂, in particular a first further acceleration signal a_{x,2} and a second further acceleration signal a_{z,2}, is subsequently detected over one rotation period or over a plurality of rotation periods, wherein the first further acceleration signal a_{x,2} specifies a tangential component and the second further acceleration signal a_{z,2} specifies a radial component of the acceleration.

With these measurement values of the further acceleration signal a₂, which were collected over at least one rotation period, a sinusoidal curve fitting 18 is subsequently carried out. As a result, a further rotation period value p₂ can be calculated by checking how the signals can best be described in the form of sine or cosine profiles by means of a fitting method (for example, by means of a least error squares sum method). In this calculation, the mean squared error is minimized as far as possible, and the further rotation period value p₂ is calculated therefrom.

In the next step, a tire radius value R can be calculated on the basis of this further rotation period value p₂ and the centrifugal acceleration value a_{c} and/or a further centrifugal acceleration value a_{c,2} also ascertained at the particular time from the first and the second further acceleration signal a_{x,2}, a_{z,2}. This tire radius value R can be used to calculate the rotation period value p₁ in a subsequent processing step. As a result, the exact tire radius need not already be known at the outset and can be approximated to the actual value of the tire radius using the combination of the further rotation period value p₂ and the centrifugal acceleration value a_{c} and/or the further centrifugal acceleration value a_{c,2}. In particular, this calculated tire radius value R can be stored and used in a recalculation of the rotation period value p₁, so that an increasingly accurate correspondence with the actual tire radius is progressively achieved.

To furthermore calculate the rotation direction of the vehicle tire, extreme values are also sought in the first and the second acceleration signal a_{x,2}, a_{z,2}. This is preferably carried out by means of a polynomial curve fitting 20; that is, a second-order or higher polynomial is fitted to a temporal signal component 21 of the first and the second further acceleration signal a_{x,2}, a_{z,2}, which is preferably shorter than a full rotation period, ideally even just half a rotation period. The signal component 21 (the signal interval, the subinterval) can be established according to the rotation period value p₂. In this signal component 21, extreme value ascertaining 22 is performed in order to identify extreme values (a maximum, a minimum) in the measured further acceleration signal a₂. If no unique extreme value is found in the selected signal interval (the sub-interval of the further acceleration signal), the extreme value ascertaining 22 can be repeated in a signal component 21 shifted by half a rotation period, by performing polynomial curve fitting 20 again. As a result, at least one extreme value can be recognized per rotation cycle, unless the signal is too noisy or otherwise unusable.

After the relevant extreme values have been found in the first and the second further acceleration signal a_{x,2}, a_{z,2}, the temporal position of the extreme values is compared with one another by means of a comparison 24. Since the first and the second further acceleration signal a_{x,2}, a_{z,2} are in a defined phase relationship relative to one another, the rotation direction D can be inferred from the sequence of whether, for example, the extremum in the first further acceleration signal a_{x,2} occurs earlier or later than the extremum in the second further acceleration signal a_{z,2}. As a result, it can be ascertained whether the vehicle tire is rotating clockwise or counterclockwise.

However, if one or both of the extreme values found are not a maximum, the time position of the relevant extreme value found can be shifted by half a period length in order to extrapolate the maximum. The rotation direction D is subsequently output taking into account the ascertained time difference between the first and the second extreme value (the maximum).

The time position t₁ of the first extreme value can be calculated as a corrected time position t_{1,c} by means of a correction 26 according to the rotation period value p₁ or further rotation period value p₂, the rotation direction D, the first acceleration signal aₓ and the further acceleration signal a_{z} as follows

$${t}_{1 , c} = {t}_{1} + D \cdot \frac{{p}_{1 , 2}}{2 π} {tan}^{- 1} ( - \frac{{a}_{x}}{{a}_{z}} )$$

Finally, the corrected time position t_{1,c} of the first extreme value, a loopback time T calculated as a time span between the corrected time position t_{1,c} and a transmission time, the rotation direction D, the tire radius value R, the rotation period value p₁ and/or the further rotation period value p₂ are output via a (wireless) communication interface.

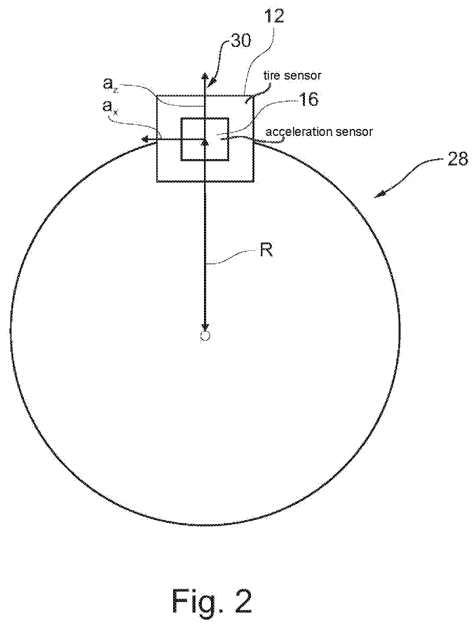

FIG. 2 shows a tire sensor in a specific embodiment of the present disclosure. The tire sensor 12 can be arranged on a vehicle tire 28 with a tire radius R as a radial distance to the axis of rotation. The tire sensor 12 can have an acceleration sensor 16 for measuring an acceleration signal. The acceleration sensor 16 can have two orthogonal measurement axes 30 for measuring a first acceleration signal aₓ in the tangential direction and a second acceleration signal a_{z} in the radial direction.

What is claimed is:

1. A method for operating a tire sensor attachable to a vehicle tire, the method comprising the following steps:
detecting an acceleration signal from an acceleration sensor of the tire sensor;
calculating a centrifugal acceleration value according to the acceleration signal;
calculating a rotation period value of a rotation period of a tire revolution of the vehicle tire at least according to the centrifugal acceleration value;
calculating a sampling frequency according to the rotation period value;
detecting a further acceleration signal from the acceleration sensor by measurement at the sampling frequency; and
calculating at least one rotation direction of the vehicle tire at least according to the further acceleration signal.

2. The method for operating according to claim 1, wherein a further rotation period value is calculated by sinusoidal curve fitting of the further acceleration signal.

3. The method for operating according to claim 2, wherein a tire radius value is calculated according to the further rotation period value.

4. The method for operating according to claim 3, wherein the rotation period value is further calculated according to a previously calculated tire radius value.

5. The method for operating according to claim 1, wherein the further acceleration signal includes a first further acceleration signal and a second further acceleration signal.

6. The method for operating according to claim 5, wherein at least one absolute first extreme value is identified in the first further acceleration signal and one absolute second extreme value is identified in the second further acceleration signal in each case by polynomial curve fitting of the first and the second further acceleration signals.

7. The method for operating according to claim 6, wherein the polynomial curve fitting is limited to a signal component, spanned by a time range, of the further acceleration signal and the time range is smaller than one rotation period.

8. The method for operating according to claim 6, wherein the rotation direction is calculated according to a relative time position of the first and the second extreme values relative to one another.

9. The method for operating according to claim 6, wherein a time position of at least the first extreme value is output.

10. The method for operating according to claim 1, wherein at least one of: the acceleration signal, the further acceleration signal, the centrifugal acceleration value, the rotation period value, or the rotation direction is output via a communication interface.

11. A tire sensor for a vehicle tire of a vehicle, comprising:
an acceleration sensor;
wherein the tire sensor is configured for operation by a method for operating including:
detecting an acceleration signal from the acceleration sensor,
calculating a centrifugal acceleration value according to the acceleration signal,
calculating a rotation period value of a rotation period of a tire revolution of the vehicle tire at least according to the centrifugal acceleration value,
calculating a sampling frequency according to the rotation period value,
detecting at least one further acceleration signal from the acceleration sensor by measurement at the sampling frequency, and
calculating at least one rotation direction of the vehicle tire at least according to the further acceleration signal.
